(19) United States
(12) Patent Application Publication
(10) Pub. No.: US 2023/0096775 A1
(43) Pub. Date: Mar. 30, 2023

(54) HEATER FOR MICRORING RESONATORS

(71) Applicant: NVIDIA Corporation, Santa Clara, CA (US)

(72) Inventors: Nikola Nedovic, San Jose, CA (US); Nandish Mehta, Cupertino, CA (US); Arian Hashemi Talkhooncheh, Pasadena, CA (US)

(21) Appl. No.: 17/491,030

(22) Filed: Sep. 30, 2021

(51) Int. Cl. G02B 6/12

(52) U.S. Cl. CPC G02B 6/12007; G02B 6/29395

(57) ABSTRACT

Microring resonators are devices that includes a set of waveguides that guide light, where at least one of the waveguides is a closed loop that operates to increase an intensity of the light over each round-trip. Microring resonators can be configured to operate as light filters and/or light modulators, and have application, for example, in the field of optical communication technology. Due to temperature sensitivity of microring resonators, however, a heating device is needed to maintain a microring resonator at a desired temperature. The present disclosure provides a microring resonator heating device that includes at least two coaxially arranged contacts providing radial current flow to heat the microring resonator.

### TECHNICAL FIELD

The present disclosure relates to heating devices for microring resonators.

### BACKGROUND

A microring resonator is a device that includes a set of waveguides that guide light, where at least one of the waveguides is a closed loop that operates to increase an intensity of the light over each round-trip. The microring resonator operates such that only the resonant wavelengths are prevented from passing through the microring resonator fully, even when the input light contains multiple wavelengths. As a result the microring resonator may also function as a filter.

One useful application of microring resonators is in the context of optical communication technology, due to their ability to support very high bandwidth density (many Tb/s per fiber) over tens of meters of distance, and at very low power (in the range of pJ/b). For example, the wavelength division multiplexing (WDM) using a MUX/modulator and DEMUX/filter resonant ring structure offers a small footprint, low power and high-speed solution for packing multiple (e.g. 8-32) logical data channels onto one waveguide, each running at x10 Gb/s, providing an efficient way to pack up to about Tb/s or more on a single waveguide/fiber core.

However, current microring resonator devices are extremely temperature sensitive due to temperature sensitivity of the waveguide core silicon material index of refraction (n_{eff}), requiring close control of the local cavity temperature in order to ensure correct operation. This typically requires an active temperature control system to be deployed to lock the microring resonator to the optimal temperature at all times despite environment temperature variations. Currently, this task is typically achieved by integrating a small heater resistor very close to the cavity of the microring resonator, and varying its power dissipation to heat its local environment, including the cavity itself, to a desired temperature. When a current is passed through the heater, it self-heats, which heats the ring cavity either directly or via heat conduction through an intermediary material.

Unfortunately, existing heater designs come with disadvantages. For example, a metal heater that is implemented as a resistive metal structure in immediate vicinity of the waveguide, usually directly above it, does not impede with modulation efficiency since the heater does not obstruct the modulation portion of the microring resonator device, but in turn reduce heater efficiency as a result of their omni directionally heating of their surroundings by causing thermal cross-talk to any neighboring rings and by having a detrimental effect on modulator contacts.

As another example, a silicon heater fabricated in the same silicon slab as the ring in its immediate vicinity, and usually inside the ring, allows the thermal gradient to spread mostly horizontally through the slab and therefore usually provides better heating efficiency as well as faster heating and cooling since the heat is more localized. However, silicon heaters are more difficult to fabricate if the ring diameter is small due to the high silicon resistivity and limits on maximum available heater voltage and current range from the driving electronics. In addition, the most efficient heaters, which form the heater body from the ring cavity waveguide itself, cannot use that portion of the cavity for the modulation, resulting in lower modulation efficiency. Most importantly, silicon heaters require some silicon doping to engineer the resistivity and to make contacts, potentially leading to parasitic structures (diodes) between the heater terminals and nearby high-speed modulator terminals causing undesired electrical behavior.

There is a need for addressing these issues and/or other issues associated with the prior art heater configurations for microring resonators.

### SUMMARY

An apparatus and associated method are disclosed for a microring resonator heating device. In an embodiment, the heating device includes at least two coaxially arranged contacts providing radial current flow to heat the microring resonator.

### BRIEF DESCRIPTION OF THE DRAWINGS

FIG. 1 illustrates an apparatus including a heating device for a microring resonator, in accordance with an embodiment.

FIG. 2 illustrates an apparatus including a heating device with a ring shaped outer electrode and an inner electrode within an interior of a microring resonator, in accordance with an embodiment.

FIG. 3 illustrates an apparatus including a heating device with a multi-electrode perimeter and an inner electrode within an interior of a microring resonator, in accordance with an embodiment.

FIG. 4 illustrates a method of operation of an apparatus including a heating device within an interior of a microring resonator, in accordance with an embodiment.

### DETAILED DESCRIPTION

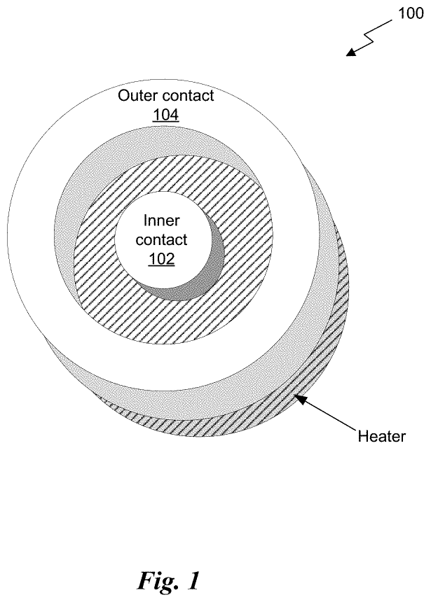

FIG. 1 illustrates an apparatus 100 including a heating device for a microring resonator, in accordance with an embodiment. In the context of the present description, a microring resonator is a physical ring-shaped device that includes a set of waveguides that each guide light in a certain direction, where at least one of the waveguides is a closed loop that operates to adjust the light over each round-trip, such as by increasing an intensity of the light over each round-trip.

In an embodiment, the microring resonator includes an input waveguide that receives light as input (e.g. from a bus or other input source) and that transmits (i.e. guides) the input light to the closed loop waveguide. In an embodiment, the closed loop waveguide in turn operates to adjust the light over one or more round-trips due to constructive interference. In an embodiment, an output waveguide of the microring resonator transmits the adjusted light from the closed loop waveguide out of the microring resonator (e.g. to the bus or other output destination).

In an embodiment, the microring resonator may operate such that only the resonant wavelength(s) of the light are prevented from passing through the microring resonator fully, even when the input light contains multiple wavelengths. As a result, the microring resonator may function as a filter for the input light. In an embodiment, the microring resonator may function as a modulator of the input light. Modulation can be obtained by the microring resonator shifting its resonance wavelength, such as through a change in its carrier density (and therefore refractive index) by applying an external voltage (e.g. to a PN junction embedded in the device).

To regulate a temperature of the microring resonator, for example such that the microring resonator operates to filter and/or modulate the input light within a specified range, the apparatus 100 includes a heating device that in turn includes at least two coaxially arranged contacts 102, 104 providing radial current flow. The term “coaxially,” as used herein, refers to having a common axis. The term “radial,” as used herein, refers to an outward direction from one or more locations on a center point.

In the embodiment shown, the at least two coaxially arranged contacts 102, 104 include an inner contact 102 and an outer contact 104, where the outer contact 104 forms a ring-shaped perimeter around the inner contact 102. While the outer contact 104 is shown as a solid ring forming the perimeter around the inner contact 102, in another embodiment the outer contact 104 may be a plurality of spaced apart contacts situated as a perimeter around the inner contact 102. Of course, other configurations for the two or more coaxially arranged contacts 102, 104 may also be used so long as the configurations enable the current to flow radially from at least one contact of the at least two coaxially arranged contacts 102, 104 to at least one other contact of the at least two coaxially arranged contacts 102, 104. Examples of some of such embodiments will be described below with reference to some of the subsequent figures.

In an embodiment, the at least two coaxially arranged contacts 102, 104 may be silicon contacts. In another embodiment, the at least two coaxially arranged contacts 102, 104 may be electrodes. In order to provide the radial current flow, at least one of the two or more coaxially arranged contacts 102, 104 may be connected (e.g. coupled) to a dynamic voltage source. The term “connected” or “coupled” refers to any direct coupling (i.e. with nothing therebetween), any indirect coupling (i.e. with one or more elements or space situated therebetween), partial coupling, completing coupling, and/or any other coupling capable of connecting different elements. Any gaps or space between elements may be unfilled (e.g. composed of air) or may be filled with some substance.

The dynamic voltage source may be capable of dynamically adjusting a voltage supplied to the connected contact. The current, and therefore heat, generated by the voltage may therefore flow radially from the contact connected to the dynamic voltage source. To this end, the heating device may change temperature as a function of the voltage supplied to the connected contact by the dynamic voltage source.

In an embodiment, the voltage supplied by the dynamic voltage source may be selected based on a measurement of a current temperature (e.g. of the microring resonator). Thus, the voltage may be selected as a function of the current temperature and a specified (desired) temperature range. For example, a voltage supplied by the dynamic voltage source may be increased when the current temperature is below the specified temperature range, may be decreased when the current temperature is above the specified temperature range, or may remain unchanged when the current temperature is within the specified temperature range. The current temperature may be provided by an external measurement device configured to measure the current temperature, and an external controller may use the current temperature and the specified temperature range to select the voltage and to control the dynamic voltage source to supply the selected voltage.

In one embodiment, at least one other one of the two or more coaxially arranged contacts 102, 104 may be connected to a constant voltage source. The constant voltage source may be ground, such that the contact connected to the constant voltage source grounds the heating device. Of course, the constant voltage source may supply any constant voltage which may be used as a reference voltage with respect to the voltage supplied by the dynamic voltage source.

In the present embodiment shown, the inner contact 102 may be connected to the dynamic voltage source and the outer contact 104 may be connected to the constant voltage source via a heater on which the inner contact 102 and the outer contact 104 are situated. The voltage supplied to the inner contact 102 by the dynamic voltage source may cause a current to flow radially from the inner contact 102 to the outer contact 104, thereby heating both the inner contact 102 and the outer contact 104. The heater may be unetched slab in one embodiment, or etched slab in another embodiment (where etched refers to a top portion of silicon being removed so that only a bottom portion remains), but in either case the heater may be doped silicon.

As noted above, the heating device is provided to regulate a temperature of the microring resonator. Accordingly, the heating device may be situated in a vicinity of the microring resonator that allows the heat of the heating device to transfer to the microring resonator. In an embodiment, the heating device may be situated in an interior of the microring resonator. In an embodiment, the heating device may be situated on a same slab as the microring resonator. The heating device may be directly coupled to the microring resonator (e.g. to an outward doped material of the microring resonator), or may be indirectly coupled to the microring resonator (e.g. with an undoped silicon material situated between the heating device and an outward doped material of the microring resonator).

In an embodiment (not shown), the apparatus 100 may also include the microring resonator. In an embodiment, the apparatus 100 may also include a bus from which the input light is provided to the microring resonator and/or to which the output light is provided from the microring resonator. In an embodiment, the apparatus 100 may also include a continuous slab on which the microring resonator and/or heating device are situated. In an embodiment, the apparatus 100 may also include the dynamic and constant voltage sources. In an embodiment, the apparatus 100 may not require special metal layers and/or inter-layer metals for heating the microring resonator.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

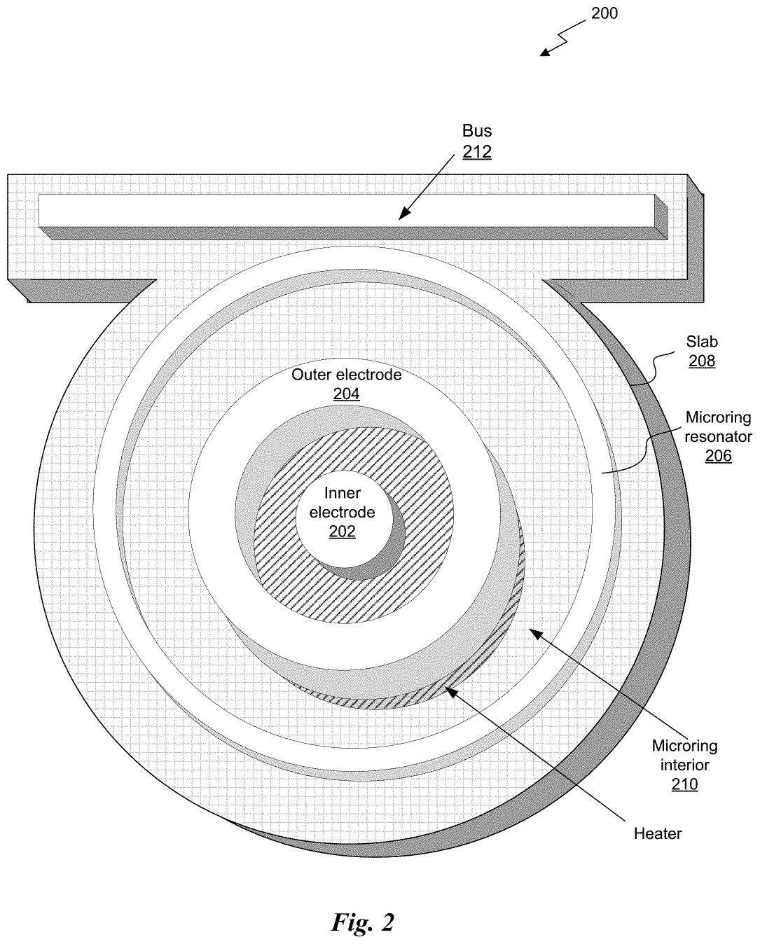

FIG. 2 illustrates an apparatus 200 including a heating device with a ring shaped outer electrode and an inner electrode within an interior of a microring resonator, in accordance with an embodiment. It should be noted that the aforementioned definitions and/or description may equally apply to the description below.

A heating device, comprised of an inner electrode 202 and an outer electrode 204 situated on a heater made of an etched doped silicon slab or unetched doped silicon slab, is situated on an undoped slab 208. Also situated on the slab 208 is a microring resonator 206. The microring resonator 206 operates to receive light from a bus 212, adjust the light, and output the adjusted light back to the bus 212. The heating device operates to heat the microring resonator 206 as needed to maintain the temperature of the microring resonator 206 within a specified temperature range.

In the present embodiment, the inner electrode 202 of the heating device is a solid cylindrical shaped component situated in an interior of the solid ring-shaped outer electrode 204 of the heating device. An area between the outer perimeter of the inner electrode 202 and the inner perimeter of the outer electrode 204 may also include a “ridge” of doped silicon that may be etched or unetched. As another option (not shown), the inner electrode 202 may be formed as any other three-dimensional (3D) shape, and/or the inner electrode 202 may be formed to have a hollow center in order to alleviate the inner electrode 202 as a hotspot and in turn improve efficiency of the heating device.

The inner electrode 202 is connected to a dynamic voltage source which dynamically supplies a voltage to the inner electrode 202. A current resulting from the voltage radially flows from the inner electrode 202 to the outer electrode 204. The heating device is situated in the interior 210 of the microring resonator 206. Accordingly, the current may flow radially from the center of the heating device (i.e. the inner electrode 202) to the periphery, which in turn will radially heat the microring resonator 206. The heating device may be made of a silicon material that is appropriately doped and sized to achive a desired resistance, limited to several micrometers in radius by the ring size of the microring resonator 206. In an embodiment where the inner electrode 202 has a hollow center (e.g. resembles a thick ring), the heater resistance may be reduced the generated heat may be distributed and pushed outward, allowing more heat and larger temperature difference to develop in the microring resonator 206.

In an embodiment, the slab 208 between the outer electrode 204 of the heating device and the inner electrode of the microring resonator 206 may be undoped. In other words, an undoped silicon may exist between the outer perimeter of the outer electrode 204 (i.e. the outer perimeter of the heating device) and the outward doped material of the microring resonator 206 to constitute a low parasitic PiN, PiP, or NiN device. In another embodiment, the slab 208 between the outer electrode 204 of the heating device and the inner electrode of the microring resonator 206 may form a PN junction. In other words, direct contact between the outer electrode 204 of the heating device and the outward doped material of the microring resonator 206 may constitute a low parasitic PN device.

In an embodiment, the outer electrode 204 may be connected to a constant voltage source (e.g. ground or a power supply) to prevent cross-talk between the inner electrode 202 and the microring resonator 206. In an embodiment, the voltage at the outer electrode 204 (and optionally the doping of the outer electrode 204) may be chosen so that the parasitic PN or PiN device formed between the heating device and an inner electrode of the microring resonator 206 is always reversed-biased. This may be accomplished by connecting the outer electrode 204 to the constant voltage source which supplies the constant voltage. For example, if the inner electrode of the microring resonator 206 is of N-type with 0-1 volt (0V-1V) swing, the heating device may be made out of a P-type material and the outer electrode 204 may be connected to 0V. In this way, the parasitic PN junction (if no intrinsic silicon buffer is left between the two) or PiN junction (with intrinsic buffer) never turns on, regardless of the voltage at the microring resonator 206 as long as it is within its legal limits, and the only effect the heating device has to the microring resonator 206 is additional parasitic capacitance.

In an embodiment, due to high thermal conductivity of silicon (used to form the heating device) compared to the surrounding SiO₂, most of the heat generated in the heating device, apart from that which goes up to the contacts, may radiate outward through the slab 208, across the parasitic PN or PiN junction, to heat the microring resonator 206.

The radial heating device described above may provide low heater resistance (as compared with other configurations of silicon heating devices), which approaches that of existing metal heaters, while also being more suitable for maximizing power dissipation given typical on-die voltages and currents. While the heater resistivity depends on the silicon doping, this low heater resistance comes from the geometry of the resistor and the fact that the effective length of the resistor is smaller and its cross section is larger than those of other configurations of silicon heating devices. The low heater resistance may allow for a high tuning range.

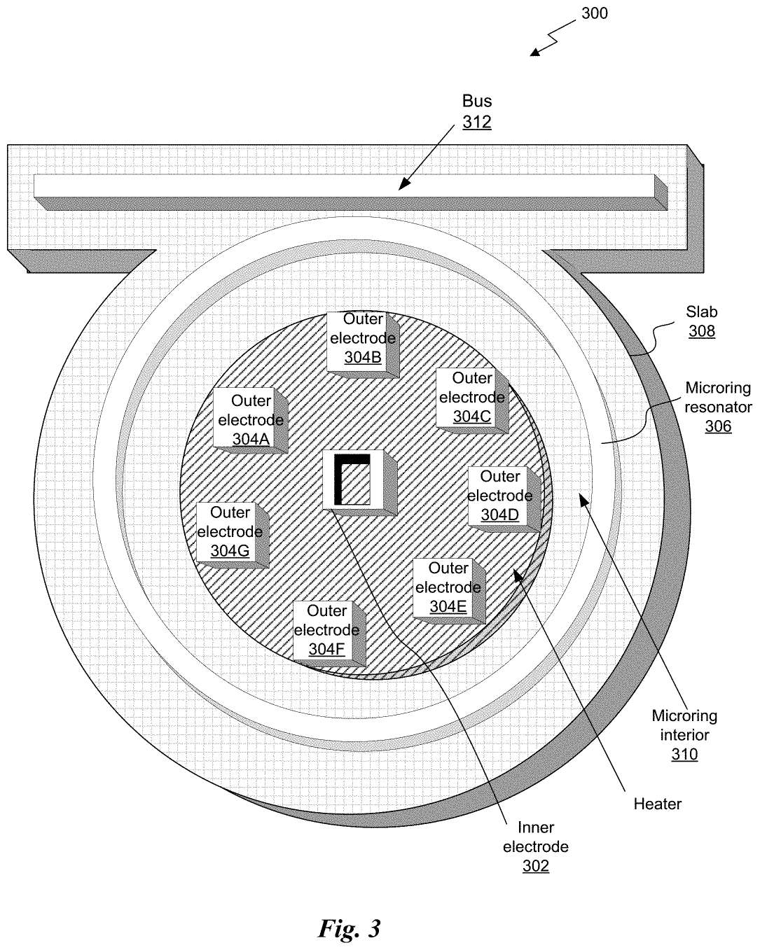

FIG. 3 illustrates an apparatus 300 including a heating device with a multi-electrode perimeter and an inner electrode within the interior of a microring resonator, in accordance with an embodiment. It should be noted that the aforementioned definitions and/or description may equally apply to the description below.

A heating device, comprised of an inner electrode 302 and a plurality of outer electrodes 304A-G situated on a heater made of an etched doped silicon slab or unetched doped silicon slab, is situated on an undoped slab 308. Also situated on the slab 308 is a microring resonator 306. The microring resonator 306 operates to receive light from a bus 312, adjust the light, and output the adjusted light back to the bus 312. The heating device operates to heat the microring resonator 306 as needed to maintain the temperature of the microring resonator 306 within a specified temperature range.

In the present embodiment, the inner electrode 302 of the heating device is a cube-shaped component with a (e.g. doped and uncontacted or undoped) silicon center that is situated in the interior of a ring-shaped perimeter formed by the plurality of outer electrodes 304A-G. While the inner electrode 302 and the outer electrodes 304A-G are shown as cube shaped, it should be noted that the electrodes may take other desired shapes, such as a cylindrical shape. Also, in the present embodiment, the plurality of outer electrodes 304A-G may be connected (e.g. via a doped silicon). An area between the outer perimeter of the inner electrode 302 and the inner perimeter of the outer electrode 304 may include a “ridge” of doped silicon that may be etched or unetched. The silicon center of the inner electrode 302 may prevent current from going through and thus prevent the inner electrode 302 from forming a hotspot on the heating device, and in turn may improve efficiency of the heating device.

Similar to the configuration of FIG. 2, the inner electrode 302 is connected to a dynamic voltage source which dynamically supplies a voltage to the inner electrode 302. A current resulting from the voltage radially flows from the inner electrode 302 to the outer electrodes 304A-G. The heating device is situated in the interior 310 of the microring resonator 306. Accordingly, the current may flow radially from the center of the heating device (i.e. the inner electrode 302) to the periphery, which in turn will radially heat the microring resonator 306. The heating device may be made of a silicon material that is appropriately doped and sized to achieve a desired resistance, limited to several micrometers in radius by the ring size of the microring resonator 306.

In an embodiment, the slab 308 between the outer electrodes 304A-G of the heating device and the inner electrode of the microring resonator 306 may be undoped. In other words, an undoped silicon ring may exist between the outer perimeter of the outer electrodes 304A-G (i.e. the outer perimeter of the heating device) and the outward doped material of the microring resonator 306 to constitute a low parasitic PiN, PiP, or NiN device. In another embodiment, the slab 308 between the outer electrodes 304A-G of the heating device and the inner electrode of the microring resonator 306 forms a PN junction. In other words, direct contact between the outer electrodes 304A-G of the heating device and the outward doped material of the microring resonator 306 may constitute a low parasitic PN device.

In an embodiment, the outer electrodes 304A-G may be connected to a constant voltage source (e.g. ground or a power supply) to prevent cross-talk between the inner electrode 302 and the microring resonator 306. In an embodiment, the voltage at the outer electrodes 304A-G (and optionally the doping of the outer electrodes 304A-G) may be chosen so that the parasitic PN or PiN device formed between the heating device and an inner electrode of the microring resonator 306 is always reversed-biased. This may be accomplished by connecting the outer electrodes 304A-G to the constant voltage source which supplies the constant voltage.

In an embodiment, due to high thermal conductivity of silicon (used to form the heating device) compared to the surrounding SiO₂, most of the heat generated in the heating device, apart from that which goes up to the contacts, may radiate outward through the slab 308, across the parasitic PN or PiN junction, to heat the microring resonator 306.

Also similar to the configuration of FIG. 2, the radial heating device described above may provide low heater resistance (as compared with other configurations of heating devices), which approaches that of existing metal heaters, while also being more suitable for maximizing power dissipation given typical on-die voltages and currents. While the heater resistivity depends on the silicon doping, this low heater resistance comes from the geometry of the resistor and the fact that the effective length of the resistor is smaller and its cross section is larger than those of other configurations of silicon heating devices.

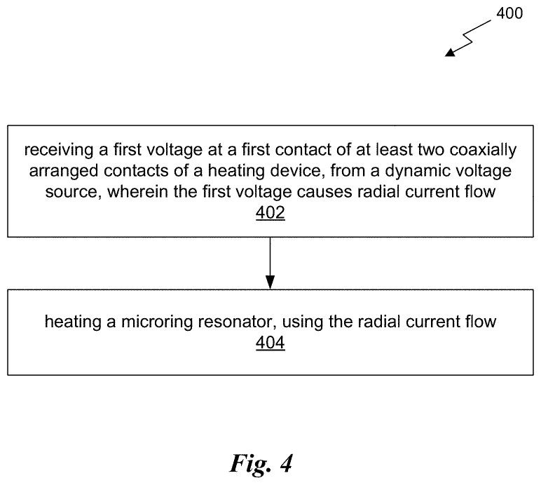

FIG. 4 illustrates a method 400 of operation of an apparatus including a heating device within the interior of a microring resonator, in accordance with an embodiment. The method 400 is carried out at a device including a microring resonator and a heater having at least two coaxially arranged contacts providing radial current flow. For example, the method 400 may be carried out using the apparatus 200 of FIG. 2 or the apparatus 300 of FIG. 3. The method may be carried out to maintain a temperature of the microring resonator within a specified temperature range, which in turn may ensure that the microring resonator operates within a specified range when filtering and/or modulating light.

In operation 402, a first voltage is received at a first contact of the at least two coaxially arranged contacts, from a dynamic voltage source, wherein the first voltage causes the radial current flow. For example, the currently may flow radially from the first contact to a second contact (or plurality of second contacts). To this end, the heater, comprised of the coaxially arranged contacts, may be configured to change temperature as a function of the first voltage.

In an embodiment, a second voltage may also be received at the second contact of the at least two coaxially arranged contacts, from a constant voltage source. For example, the second voltage may be zero (0V). This constant voltage may prevent cross-talk between the first contact supplied with the dynamic voltage and the microring resonator.

In operation 404, the microring resonator is heated, using the radial current flow. In particular, since the heating device is situated in the interior of the microring resonator, the radially flowing current may cause the heat from the heating device to flow outward from the heating device to the microring resonator. This configuration may provide localized thermal tuning of the microring resonator, whereby the method 400 may be repeated for different voltages selected for the first contact in order to maintain a temperature of the microring resonator within a specified temperature range.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. An apparatus, comprising:
a heating device for a microring resonator, including:
at least two coaxially arranged contacts providing radial current flow.

2. The apparatus of claim 1, wherein the at least two coaxially arranged contacts are silicon.

3. The apparatus of claim 1, wherein the at least two coaxially arranged contacts include:
a first contact connected to a dynamic voltage source, and
at least one second contact connected to a constant voltage source.

4. The apparatus of claim 3, wherein the first contact is a first electrode and the at least one second contact is at least one second electrode.

5. The apparatus of claim 3, wherein the first contact causes the heating device to change temperature as a function of a voltage supplied by the dynamic voltage source.

6. The apparatus of claim 3, wherein the at least one second contact grounds the heating device.

7. The apparatus of claim 3, wherein the at least one second contact forms a perimeter around the first contact.

8. The apparatus of claim 7, wherein the at least one second contact is a solid ring forming the perimeter around the first contact.

9. The apparatus of claim 7, wherein the at least one second contact is a plurality of second contacts situated to form the perimeter around the first contact.

10. The apparatus of claim 7, wherein the current flows radially from the first contact to the at least one second contact.

11. The apparatus of claim 3, wherein the first contact has a doped and uncontacted or undoped silicon center.

12. The apparatus of claim 1, the apparatus further comprising:
the microring resonator,
wherein the heating device is situated in an interior of the microring resonator.

13. The apparatus of claim 12, wherein the heating device is situated on a same slab as the microring resonator.

14. The apparatus of claim 12, wherein the microring resonator functions as a modulator.

15. The apparatus of claim 12, the apparatus further comprising:
an undoped silicon material situated between the heating device and an outward doped material of the microring resonator.

16. The apparatus of claim 12, wherein the heating device is directly coupled to an outward doped material of the microring resonator.

17. A method, comprising:
at a device including a microring resonator and a heater having at least two coaxially arranged contacts providing radial current flow:
receiving a first voltage at a first contact of the at least two coaxially arranged contacts, from a dynamic voltage source, wherein the first voltage causes the radial current flow; and
heating the microring resonator, using the radial current flow.

18. The method of claim 17, wherein the heater changes temperature as a function of the first voltage.

19. The method of claim 17, further comprising:
receiving a second voltage at a second contact of the at least two coaxially arranged contacts, from a constant voltage source.

20. The method of claim 19, wherein the second voltage is zero.

21. The method of claim 17, wherein the microring resonator modulates light.

22. An apparatus, comprising:
a microring resonator; and
a heating device, including:
at least two coaxially arranged contacts providing radial current flow to heat the microring resonator.

23. The apparatus of claim 22, wherein the at least two coaxially arranged contacts are silicon.

24. The apparatus of claim 22, wherein the at least two coaxially arranged contacts include:
a first contact connected to a dynamic voltage source, and
at least one second contact connected to a constant voltage source.

25. The apparatus of claim 24, wherein the first contact is a first electrode and the at least one second contact is at least one second electrode.

26. The apparatus of claim 24, wherein the first contact causes the heating device to change temperature as a function of a voltage supplied by the dynamic voltage source.

27. The apparatus of claim 24, wherein the at least one second contact grounds the heating device.

28. The apparatus of claim 24, wherein the at least one second contact forms a perimeter around the first contact.

29. The apparatus of claim 28, wherein the at least one second contact is a solid ring forming the perimeter around the first contact.

30. The apparatus of claim 28, wherein the at least one second contact is a plurality of second contacts situated to form the perimeter around the first contact.

31. The apparatus of claim 28, wherein the current flows radially from the first contact to the at least one second contact.

32. The apparatus of claim 31, wherein the first contact has a doped and contacted or undoped silicon center.

33. The apparatus of claim 32, wherein the heating device is situated in an interior of the microring resonator.

34. The apparatus of claim 33, wherein the heating device is situated on a same slab as the microring resonator.

35. The apparatus of claim 33, wherein the microring resonator functions as a modulator.

36. The apparatus of claim 33, the apparatus further comprising:
an undoped silicon material situated between the heating device and an outward doped material of the microring resonator.

37. The apparatus of claim 33, wherein the heating device is directly coupled to an outward doped material of the microring resonator.
